(19) United States
(12) Patent Application Publication
(10) Pub. No.: US 2006/0279788 A1
(43) Pub. Date: Dec. 14, 2006

(54) Automatic generation of supercell halftoning threshold arrays for high addressability devices

(75) Inventors: Kenneth R. Crounse, Somerville, MA (US); Vladimir Levantovsky, North Andover, MA (US)

Correspondence Address: Breiner & Breiner, L.L.C., P.O. Box 19290, Alexandria, VA, 22320-0290, US

(73) Assignee: MONOTYPE IMAGING, INC., Woburn, MA (US)

(21) Appl. No.: 11/149,285

(22) Filed: Jun. 10, 2005

(51) Int. Cl. G06K 15/00

(52) U.S. Cl. 358/3.03; 358/3.2; 358/3.02; 358/3.23

(57) ABSTRACT

The automatic generation and use of halftone supercell threshold arrays suitable for high addressability output devices, particularly ones with constraints on sub-pixel combinations or geometries is disclosed. An example of a high addressability device is a laser printer using a pulse width modulator. The invention can further extend the usefulness of supercell halftone screening systems.

### FIELD OF THE INVENTION

The automatic generation and use of halftone supercell threshold arrays suitable for high addressability output devices, particularly ones with constraints on sub-pixel combinations or geometries is disclosed. An example of a high addressability device is a laser printer using a pulse width modulator. The invention can further extend the usefulness of supercell halftone screening systems.

### BACKGROUND OF THE INVENTION

Images are typically recorded and stored as contone images in which each image element or pixel has a color tone value. For example, consider a digitally stored “black and white” image—each image element will have a corresponding value setting its tone, among 256 gradations, for example, between white and black. Color images may have three or more tone values for each of the primary colors.

Many printing processes, however, cannot render an arbitrary color tone value at each addressable location or pixel. Most flexographic, xerographic, inkjet, offset printing, electrophotographic (including, for example laser printers, light emitting diode (LED) printers, multifunction devices that include print capabilities, and digital copiers) processes are basically binary procedures in which color or no color is printed at each pixel. At each addressable point on a piece of paper, these processes can generally either lay down one or more dots of colorant or colorants, or leave the spot blank.

In the case of a laser printer, at each addressable point on a piece of paper, the device can generally either lay down a dot of black or colored toner, or combination thereof, or leave the spot blank. This occurs because in most electrophotography-based devices, toner is selectively transferred to a drum that has been electrostatically charged in the pattern of the desired image. The toner is then transferred from the drum to the print media and then fused there. In some color devices, a series of drums are provided for each of the different image separations or color planes. In a common four-color printing process, the cyan, magenta, yellow, and black toners are added by successive drums to build the color spectrum on the paper media. In other arrangements, the color spectrum is built on a single drum and then transfered to the media.

Offset printing is used in many commercial applications. The print media travels through multiple printing press units. Each unit sequentially applies different image separations or color planes to the paper web. For example in a common four-color printing process, the cyan, magenta, yellow, and black inks are added by successive printing press units to build the color spectrum on the web.

The image is held on these press units typically on a printing plate. Separate printing plates are provided for each of the separations in each of the press units. Newer computer to plate systems enable the generation of the image directly on these plates. In other systems, however, the image is first formed on a film substrate and then transferred to the printing plate.

Converting a contone image to a format compatible with these printing process restrictions is termed halftoning. Color tone values of the contone image elements become binary dot patterns that, when averaged, appear to the observer as the desired color tone value. The greater the coverage provided by the dot pattern, the darker the color tone value.

A number of techniques exist for determining how to arrange the halftone dots in the process of transforming the contone image into the halftone image. A common approach to creating digital halftones uses threshold masks or screens to simulate the classical optical approach. These masks are arrays of thresholds that spatially correspond to the addressable points or pixels on the output medium. At each location, an input value from the contone image is compared to a threshold to make the decision whether to print a dot or not.

In the simplest case, classical screens produce halftone dots that are arranged along parallel lines in two directions, i.e., at the vertices of a parallelogram tiling in the plane of the image. If the two directions are orthogonal, the screen can be specified by a single angle and frequency. The halftone dots grow according to a spot function as the desired coverage increases. This is often called “AM” (amplitude modulation) screening.

Agfa Balanced Screening (ABS), which is described in U.S. Pat. No. 5,155,599, allows the use of a square tile to produce screens closely approximating any angle or reasonable frequency. ABS is an example of a supercell technique: the threshold array (tile) contains many halftone cells. The ABS parameters determine the number of halftone dots contained within a tile and the location of the dot centers.

In ABS, the dot centers do not necessarily lie on the underlying printer grid, but may be “virtual.” When the threshold mask is being computed, the halftone dots are created out of real device dot locations (pixels) that grow around these virtual centers. Furthermore, to allow for more possible levels of coverage, the dot growth is preferably dithered. This means that the halftone dots do not grow synchronously; instead each is grown independently in a pre-determined order.

Some devices, however, have the ability to control the placement of an output spot on a finer scale than the device pixel size itself. These are called high addressability devices. Typically this fine control is only along one of the dimensions. For example, a laser printer works by scanning a laser spot across a photo-sensitive drum. The laser scans across the page horizontally and then moves down one pixel vertically. Therefore, it is possible to provide fine addressability in the horizontal (x-axis) direction but not necessarily in the vertical, or y-axis, direction.

The pixel grid of a typical electrophotographic printing device is established by two parameters: the clock frequency of the signal sent to the scanning laser of the laser printer, imagesetter, or platesetter (or ink drop depositor in the case of an inkjet printer) in the scan (or X-axis) direction, and the stepper motor/drum/feed mechanism rate in paper feed (or Y-axis) direction. Parameters are typically set to achieve a standard resolution, such as 600 dots per inch (dpi), in both directions.

Improvements in lasers and electronic bandwidths have allowed the use of higher scanning frequencies providing higher resolutions in the X direction (e.g. 2400 dpi), which can provide prints with reduced graininess, increased detail, and reduced moiré via improved halftone geometry. However, such systems require the use of higher quality toners and inks and more expensive components, and may be slower due to the increase in data in the imaging pipeline.

High addressability devices implement an electronic hardware control technique called a Pulse Width Modulation (PWM). Typically, PWM will not allow an arbitrary scanning signal. Instead, constraints will exist on the possible signals, such as allowing only one pair of on-off transitions per pixel. Therefore, it may not be possible to address each subpixel independently.

### SUMMARY OF THE INVENTION

Determining halftone patterns for a high-addressability device by hand is an enormous task given the very large numbers of possible subpixel combinations. This is especially true when building a supercell array, where the cells within the array are not necessarily the same size or shape.

Threshold arrays can be automatically generated at the higher subpixel resolution using conventional systems, such as ABS. Here, however, problems arise due to the particular constraints that may be imposed by the PWM—there may not be a direct correspondence to the required signal.

One approach would be to post-process the signal generated by such a conventional halftoning screen so that the subpixel combinations are modified to be consistent with the PWM capabilities. This approach, however, can be a time consuming process.

Another approach would be to create a multi-level halftone screen at the standard, lower pixel resolution. Then, after the multi-level signal is created, later in the imaging pipeline, the screen is converted to a valid PWM signal by a real-time algorithm at the subpixel resolution.

A common method is to center a pulse of the appropriate width. Another method is to adaptively left, center or right justify a pulse of the appropriate width to be contiguous with adjacent pulses. This method does not preserve the exact halftone dot geometry, however. Furthermore, it does not guarantee the resulting halftone patterns obey the stacking constraint, which is desirable in order to provide for smooth transitions. Finally, other methods, not based on threshold arrays, may be difficult to linearize by a compensation procedure.

The invention covers the automatic generation and use of halftone supercell threshold arrays suitable for high addressability output devices, particularly one with constraints on sub-pixel combinations or geometries. An example of a high addressability device is a laser printer using a pulse width modulator. The invention can further extend the usefulness of ABS to such devices.

In general, according to one aspect, the invention features a method for generating halftone screens. This method comprises defining valid subpixel combinations and generating halftone screens at the subpixel resolution based on the valid subpixel combinations.

In one embodiment, this is achieved by processing intermediate screens to remove invalid subpixel combinations to generate the halftone screens.

In another embodiment, a spot function is defined based on the valid combinations. This allows halftone screens with valid subpixel combinations to be generated directly.

In either case, according to a preferred embodiment of the invention, the halftone screens are applied to image data to generate halftone images. This is preferably accomplished by converting subpixel combinations of the halftone images to pulse width modulation (PWM) signals, which are sent to a print engine.

Print engines that accept PWM signals are a class of print engines that allow for subpixel resolution using this modulation technique.

In various embodiments, the subpixel combinations comprise right, left, or center justified pulses.

One characteristic is that the halftone cells may not exactly lie on the same subpixels. The periodicity of the halftone cells in the pixel domain is not limited to an integer periodicity.

In general, according to another aspect, the invention features a printing system. This printing system comprises a print engine capable of printing subpixel combinations within a pixel period resolution. Thus, the pixels are effectively divided into higher resolution subpixels. Typically, however, the print engine is not capable of printing every possible combination of subpixels. Instead, the print engine mechanics provide certain constraints, thus, only certain combinations of subpixels can in fact be rendered by the print engine.

A halftone screen store is further provided for holding halftone screens at the subpixel resolution. The halftone screens include only subpixel combinations that the print engine is capable of printing. Finally, a raster image processor is provided for converting a received image into halftone image data comprising separate halftone color separations for each of the print colors using the halftone screens.

According to one embodiment, intermediate screens are generated that are then processed to remove subpixel combinations that the print engine is not capable of printing to generate the halftone screens.

In another embodiment, a spot function of the screens is based on the subpixel combinations that the print engine is capable of printing.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of a color electrophotographic print system according to the present invention;

FIG. 2 is a flow diagram illustrating the method for driving a pulse width modulated rendering device to generate a color image according to a first embodiment of the present invention;

FIG. 3 is a flow diagram illustrating the method for driving a pulse width modulated rendering device to generate a color image according to a second embodiment of the present invention;

FIGS. 4a-4c illustrate potential subpixel combinations that a print engine is capable of rendering;

FIGS. 5a and 5b illustrate the conversion of invalid subpixel combinations to valid subpixel combinations according to the present invention;

FIG. 6 illustrates a subpixel resolution spot function according to the present invention; and

FIG. 7 illustrates line screens for cyan and magenta screens and moiré cancellation of a black line screen.

### DETAILED DESCRIPTION OF THE PREFERRED EMBODIMENTS

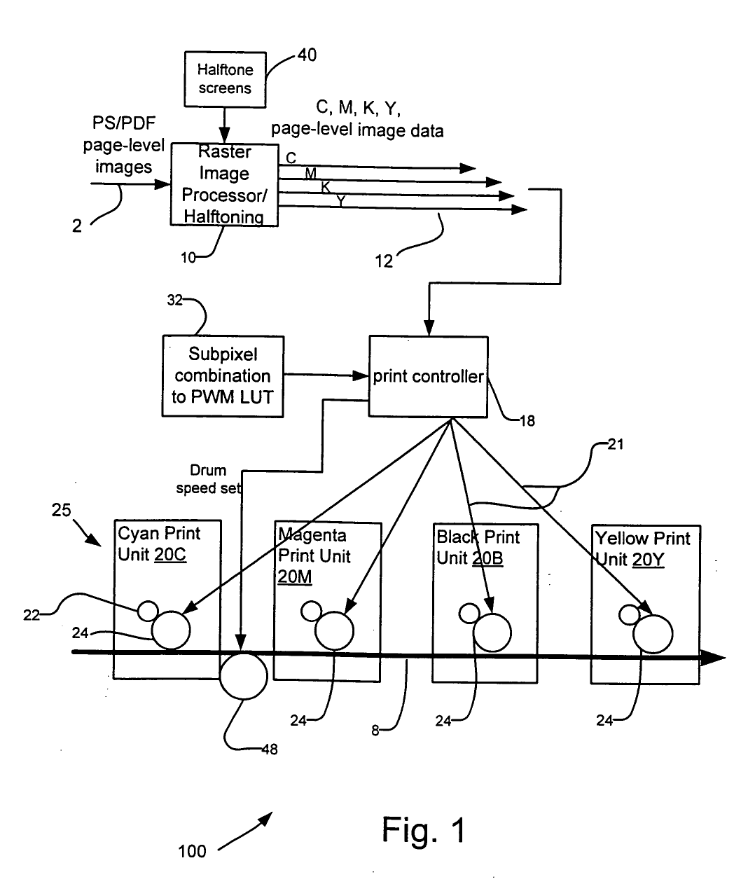

FIG. 1 shows a printing system 100 that has been constructed according to the principles of the present invention.

In the common implementation, the input source file 2 is a Postscript (or any other PDL) file, or portable document file (.pdf). This typically comprises contone images of the pages to be printed on a paper media 8. In other cases, the image is represented using GDI (graphical device interface) calls. GDI is a standard for representing graphical objects for transmission from a computer to an output device, such as a printer.

A raster image processor (RIP) 10 is then used to convert, or rip, the source file(s) or GDI into a format appropriate for offset or electrophotographic printing. That is, the page-level images are halftoned and converted into a format appropriate for raster scanning of the halftone image. Thus, the raster image processor 10 usually generates four data sets of page-level halftone image data. Each data set represents a different color plane or separation that is used in color printing units 20C, 20M, 20B, and 20Y.

In the offset printing example, the different color data sets are used in the production of plates or rollers. In a more common electrophotographic example, the data sets are used to expose the photosensitive drums 24 to create a latent electrostatic image for transferring toner to the print media 8. In other examples, however, the color spectrum is built on a single photosensitive drum and then transferred to the print media in one or more cycles.

Digital halftoning involves conversion of the contone images and text to a binary, or halftone, representation. Color tone values of the contone image elements become binary dot patterns that, when averaged, appear to the observer as the desired color tone value. The greater the coverage provided by the particular dot pattern, the darker the color tone value.

A common approach to creating digital halftones uses a threshold mask to simulate the classical optical approach. This mask is an array of thresholds that spatially corresponds to the addressable points on the output medium. At each location, an input value from the contone image is compared to a threshold to make the decision whether to print a dot or not. A small mask (tile) can be used on a large image by applying it periodically.

According to the invention, screens 40 are provided for each of the color separations. According to the invention, the pixel pitches of the screens are further divided into higher resolution subpixels. In a current embodiment, these subpixels are provided along only one axis, the horizontal, scan, or x-axis. In other embodiments, the subpixel resolution is provided along the y-axis or paper feed direction, or both the x and y axes.

Thus, the “RIPping” process yields a set of color planes. In the specific example, these are cyan, magenta, black, and yellow page-level raster image data. This is the one bit deep image data of the half-toned image at the subpixel resolution.

These page-level image data are received by a print engine or controller 18, which in the case of a laser printer is the imaging engine drive system. This device or computer controls the exposure of the photosensitive drums 24 by the light sources, such as the laser diode bars or scanning laser dots 21. The print controller 18 thus controls the deposition of the colorant on the print media 8.

In some embodiments, the engine 18 also produces drum drive signals dictating the revolution speed of the print drums 24, and thus the size of the pixels or pixel pitch in the y-axis direction.

In the example of a laser printer, the drums 24 of the color separation print units 20C, 20M, 20B, 20Y are exposed 21 with the image associated with the corresponding color so that they pick up toner from toner application drum or unit 22 in the desired pattern and transfer the toner to the media 8. Specifically, the cyan drum is imaged with the cyan separation in a cyan print unit 20C of the printer 25, the magenta drum is imaged with the magenta separation in a magenta print unit 20M, the black printing drum is imaged with the black separation in a black print unit 20B, and the yellow drum is imaged with the yellow separation in a yellow print unit 20Y. The media then successively passes through each of these print units 20C, 20M, 20B, and 20Y to receive the corresponding toner.

In the example of a platesetter, the resulting rollers or plates, which were either directly exposed in the imaging engine or produced from the film exposed in the imaging engine, are then used in the printing press. Specifically, the cyan plate is loaded into a cyan print unit 20C of the press, the magenta plate is loaded into a magenta print unit 20M, the black printing plate is loaded into the black print unit 20B, and the plate for the yellow color plane is loaded into the yellow print unit 20Y. The media, or web, then successively passes through each of these print units 20C, 20M, 20B, and 20Y, each printing unit applying its color to thereby create a full spectrum image on the media.

According to the invention, the print controller 18 also accesses a subpixel combination-to-pulse width modulation (PWM) signal converter 32. In one example, this is implemented as a look-up table (LUT). In other examples, the conversion is done algorithmically. The converter 32 is used to change subpixel combinations into an appropriate PWM signal that is used to drive the print engine 18. Specifically, the halftone image is converted to the codes accepted by the PWM engine 18 by using the grouped subpixel values as an index into look-up table 32.

In another embodiment, the engine 18 also produces a drum speed set signal that is used to set the revolution rate of the feed drum or media feed mechanism 48. This controls how fast the drum 48 turns and thus the size or pitch of the pixels or subpixels, if used, in the y-axis direction.

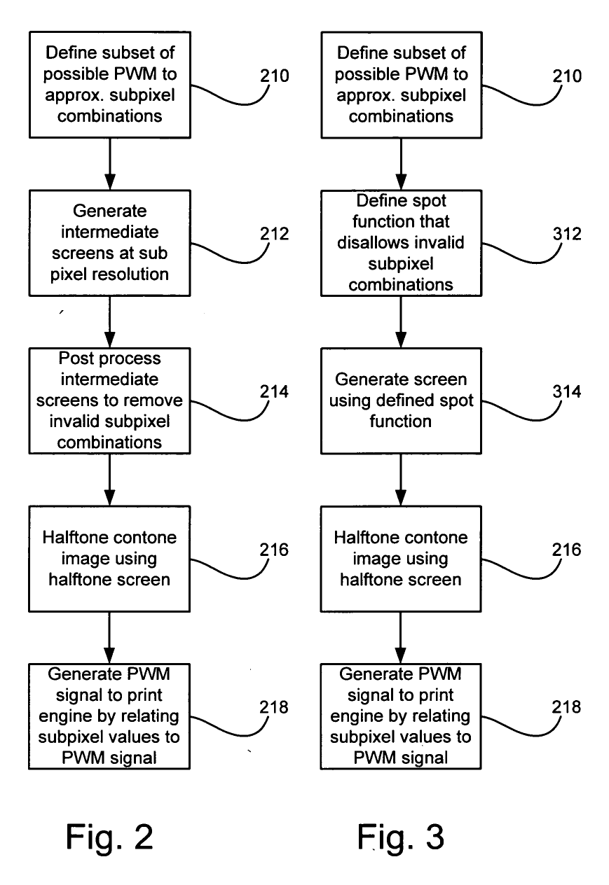

FIG. 2 illustrates a process for converting and rendering contone image data as halftone data according to the principles of the present invention.

Specifically, in step 210, a subset of possible pulse width modulation signals are defined to approximate various subpixel combinations.

Specifically, the print engine, such as the multicolor print head of the ink jet printer or the print engine 18 of the electrophotographic printer 100, are capable of printing at higher resolutions than the pixel resolution. However, these engines cannot print every possible subpixel combination. Thus, a series of pulse width modulation signals for the print engine are defined in order to approximate various subpixel combinations.

Then, in step 212, intermediate screens are generated at the subpixel resolution. These screens are generated using standard halftoning techniques. Preferably, a supercell technique is used such as Agfa balanced screening as described in the previously incorporated patent.

These conventionally-generated screens, however, do not take into account the constraints imposed by the print engine 18 of the electrophotographic printer, for example.

Thus, a post processing step 214 is performed. This changes the intermediate screens in order to remove invalid subpixel combinations.

Then, in step 216, the contone image is halftoned using the generated halftone screens.

Finally, a pulse width modulation signal is sent by the print engine 18 to the printer 25 by relating the subpixel values to the appropriate PWM signal that is compatible with the mechanical and electrical constraints of the underlying printer 25.

FIG. 3 illustrates a second embodiment of the process for halftoning at the subpixel resolutions using the PWM print system according to the principles of the present invention.

Specifically, in step 210, the subset of possible PWM signals are related to approximate subpixel combinations. In this embodiment, however, in step 312, a spot function is then defined that disallows invalid subpixel combinations. Specifically, the spot function, and how the spot function grows among the subpixels, is defined such that it avoids invalid subpixel combinations or subpixel combinations that the target engine cannot render.

Then, in step 314, screens are generated using this defined spot function. Thus, the resulting screens do not include invalid subpixel combinations.

The contone image is then halftoned using the halftone screens in step 216. Finally, the valid PWM signals are generated for the print engine 18 by relating the subpixel values or combinations to the appropriate PWM signals in step 218.

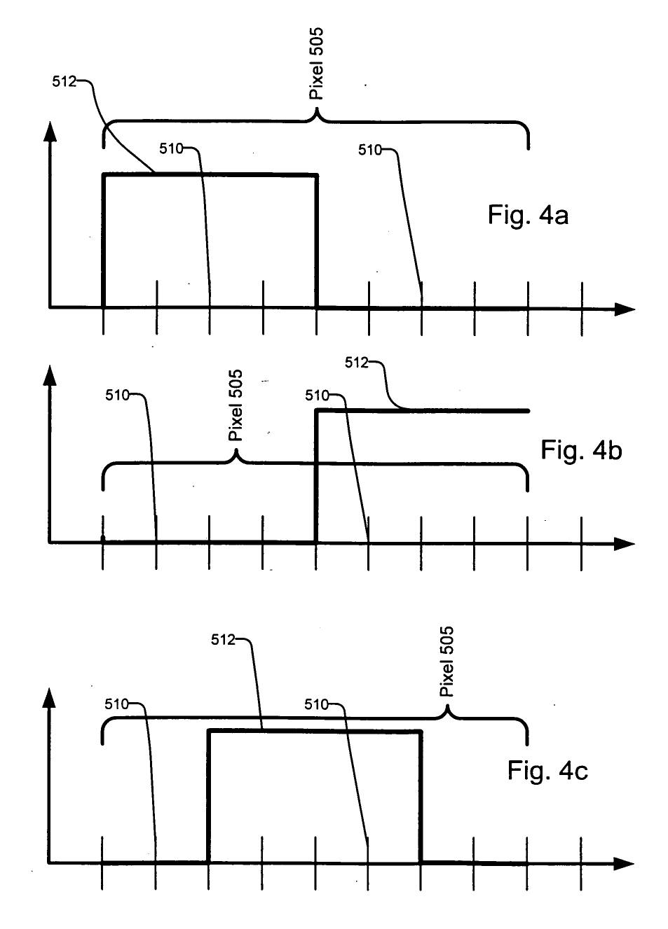

FIGS. 4a, 4b and 4c illustrate how a pixel 505 is divided into higher resolution subpixels 510. As described previously, however, because of the constraints of the print engine 18, not every combination of the subpixels 510 can be printed.

For example, a PWM chip may only be capable of producing a single pulse centered at a discrete set of positions and widths, and their inversions. Ideally it would be possible to choose pulses that correspond to each of the N positions being “on”, and all 2^{N} possible combinations thereof. However, on this particular chip, it is not possible to make more than one isolated pulse (or its inversion), and therefore there are only N²−N+2 possible pulses that can be used.

In another example, a PWM chip might only allow left, center, and right justified pulses of varying widths. In this case the chosen subset of signals would correspond to clusters of subpixels in one of these three positions.

In one example, the print engine in one example may only print a single pulse 512 or multiple pulses. Specifically, as illustrated in FIG. 4a, the print engine may only produce a left-justified pulse 512. In FIG. 4b, a right justified pulse 512 is illustrated. Finally, in FIG. 4c, a center justified pulse 512 is illustrated. In short, subset of possible PWM signals is used to approximate non-overlapping sub-pixels at a chosen addressability.

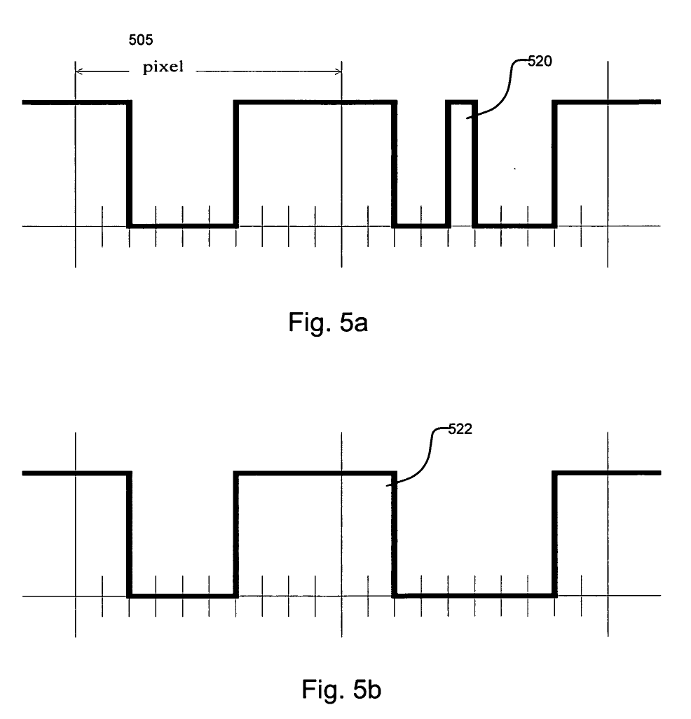

FIGS. 5a and 5b illustrate the conversion of the invalid pixel combinations to valid pixel combinations when moving from the intermediate screens to the final screens as described in step 214 of FIG. 2.

Specifically, FIG. 5a illustrates the pixel period and the corresponding underlying subpixel periods 510. Because of the constraints of the print engine, the single subpixel pulse 520 may not be capable of being reproduced. Thus, as illustrated in FIG. 5b, the single pulse 520 is removed. Instead, the pulse is merged into the adjacent pulse 522 thereby conforming to the constraints of the print engine while maintaining the underlying tone or density associated with the original halftone signal.

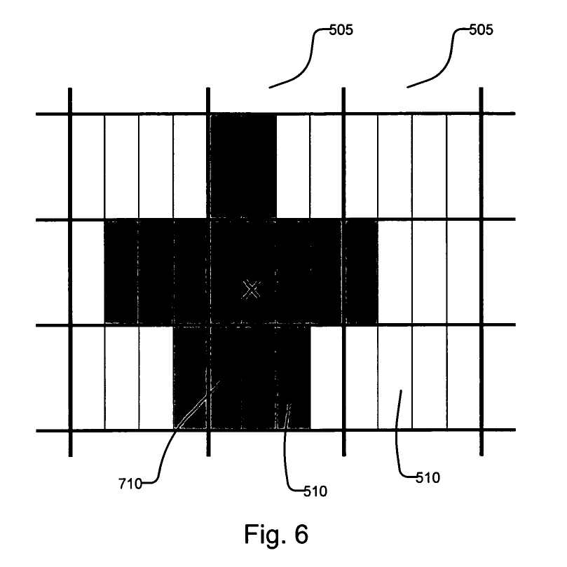

FIG. 6 illustrates a spot function that is based on the subpixel resolution. Specifically, within each pixel period 505 are corresponding subpixels 510. The spot function 710 is defined at the resolution of these subpixels. This spot function's growth, however, is constrained so that it only grows with subpixel combinations that the print engine 18 or the multi-color print head are capable of rendering on the media 8.

Besides providing a practical method to produce a threshold array (screen), using this method also produces unique quality improvements in the output.

Generally, PWM methods create multi-level output signals that will provide more output tone levels. Moreover, the pulses can be justified intelligently to reduce graininess and create an anti-aliased halftone dot.

A further geometric advantage is also provided. Since the halftone pattern is created on the sub-pixel grid, halftone dot centers are preferably placed on non-pixel boundaries. Moreover, the centers can be further placed exactly upon integer sub-pixels that are not a simple multiple of the over-sampling rate. In such cases, exact moiré-canceling screens can be created that would otherwise not be possible at the pixel resolution.

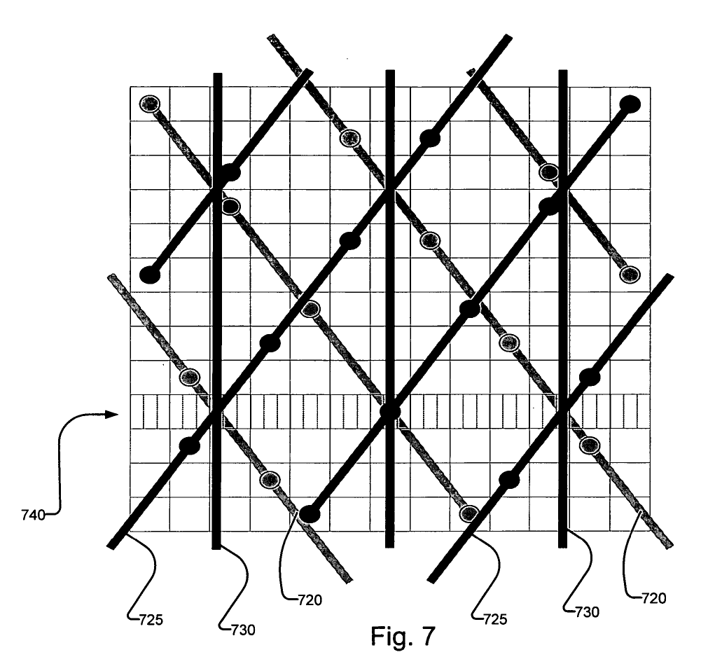

With reference to FIG. 7, assume that the pixel period is 600 dpi. In this example, the Cyan screen 720 and the magenta screen 725 are line screens with slope −3/2 and +3/2, respectively based on a square cell. This yields a screen frequency of about 166 lines per inch (lpi).

In this case, it can be shown that the moiré is canceled by a black line screen 730 at 0 degrees with period 13/3 pixels (about 138 lpi).

Using the present invention, such a screen can be created by oversampling in the horizontal scan direction by a factor of three and making a screen using conventional methods with period 13 (sub-) pixels. One line 740 of the over-sampling is shown in the diagram.

Other uses for the geometrical advantage of the method can also be found. For example, a known moirécanceling combination can be modified to produce a more balanced set of screen frequencies.

Let (x1,y1,x2,y2) be the pixel coordinates of a non-orthogonal (parallelogram-shaped) halftone cell. One well-known moiré-canceling combination is C=(7,2,2,−8), M=(2,8,7,−2), K=(5,6,5,−6), which lies in a reasonable range of screen frequencies at 1200 dpi. Clearly to use this screen set at 600 dpi, it is a simple matter to divide all coordinates by two, which gives integer pixel offsets in the y-axis and fractions of ½ on the x-axis. Therefore, a PWM scheme of two sub-pixels per cell can be used to implement this screen exactly. However, a much better result can be obtained using a present preferred embodiment. Since these cells are parallelogram-shaped, there spatial frequencies differ along the two directions. In the basic implementation the frequency for Cyan and Magenta are approximately 146 lpi and 165 lpi in the two directions, and for K they are both approximately 156 lpi at +−40 degrees. Ideally, all these frequencies would be much closer to each other and the black screen would be closer to 45 degrees.

To improve the situation, it can be seen that multiplying the x-coordinates of the screens by 6/11 instead of ½ will lead to more balanced screen set frequencies. This can be accomplished using our method by creating a tile with 6 times the number of pixels in the horizontal direction and building the original screen with only the y-coordinates divided by two using a conventional method. Then 11-times oversampling can be used with PWM to provide the correct ratio. Using this method the resulting screen frequencies are 145 and 152 lpi for C,M and 149 lpi for K at +−42 degrees.

Thus, one of the benefits of the inventive method is the ability to make screens that are not a rational in physical pixels, but on the subpixel scale. This provides a system with non-integer cells, or in other words, halftone screens are of a frequency that does not correspond to rational divisions of the pixel frequency.

While this invention has been particularly shown and described with references to preferred embodiments thereof, it will be understood by those skilled in the art that various changes in form and details may be made therein without departing from the scope of the invention encompassed by the appended claims.

It is claimed:

1. A method for generating halftone screens comprising:
defining valid subpixel combinations; and
generating halftone screens at subpixel resolutions based on the valid subpixel combinations.

2. The method as claimed in claim 1, further comprising processing intermediate screens to remove invalid subpixel combinations to generate the halftone screens.

3. The method as claimed in claim 1, further comprising defining a spot function based on the valid subpixel combinations.

4. The method as claimed in claim 3, further comprising using the spot function to generate the halftone screens.

5. The method as claimed in claim 1, further comprising apply the halftone screens to image data to generate halftone images.

6. The method as claimed in claim 5, further comprising converting subpixel combinations of the halftone images to pulse width modulation signals to a print engine.

7. The method as claimed in claim 1, wherein the valid subpixel combinations comprise right justified pulses.

8. The method as claimed in claim 1, wherein the valid subpixel combinations comprise left justified pulses.

9. The method as claimed in claim 1, wherein the valid subpixel combinations comprise center justified pulses.

10. The method as claimed in claim 1, wherein the halftone screens are non-integer in pixels.

11. The method as claimed in claim 1, wherein the halftone screens are of a spatial frequency other than an integer division of a pixel frequency.

12. A printing system comprising:
a print engine capable of printing subpixel combinations within a pixel resolution;
a halftone screen store holding a halftone screen at subpixel resolution, the halftone screen including only subpixel combinations that the print engine is capable of printing; and
a raster image processor for converting a received image into halftone image data using the halftone screen.

13. The system as claimed in claim 12, wherein the halftone screen is non-integer in pixels.

14. The system as claimed in claim 12, wherein the halftone screen is of a spatial frequency other than an integer division of a pixel frequency.

15. A printing system comprising:
a print engine capable of printing subpixel combinations within a pixel resolution;
a halftone screen store holding halftone screens at subpixel resolution, the halftone screens including only subpixel combinations that the print engine is capable of printing; and
a raster image processor for converting a received image into halftone image data comprising separate halftone color separations for each print colors using the halftone screens.

16. The printing system as claimed in claim 15, wherein intermediate screens have been processed to remove subpixel combinations that the print engine is not capable of printing to generate the halftone screens.

17. The printing system as claimed in claim 15, wherein a spot function of the halftone screens is based on the subpixel combinations that the print engine is capable of printing.

18. The printing system as claimed in claim 15, further comprising:
a print engine for rendering a pulse width modulated image data on print media;
a print driver for converting halftone image data to the pulse width modulated image data for the print engine; and
a print converter for mapping subpixel combinations of the halftone image data to pulse width modulation signals for the print engine.

19. The system as claimed in claim 15, wherein the halftone screens are non-integer in pixels.

20. The system as claimed in claim 15, wherein the halftone screens are of a spatial frequency other than an integer division of a pixel frequency.
